(19) United States
(12) Patent Application Publication
(10) Pub. No.: US 2023/0276278 A1
(43) Pub. Date: Aug. 31, 2023

(54) BEAM FAILURE FOR SERVING CELL WITH MULTIPLE ACTIVE BANDWIDTH PARTS

(71) Applicant: Lenovo (Singapore) Pte. Ltd., New Tech Park (SG)

(72) Inventors: Joachim Loehr, Wiesbaden (DE); Hyejung Jung, Northbrook, IL (US); Vijay Nangia, Woodridge, IL (US); Ravi Kuchibhotla, Chicago, IL (US)

(21) Appl. No.: 18/016,215

(22) PCT Filed: Jul. 13, 2021
(86) PCT No.: PCT/IB2021/056316

§ 371 Date: Jan. 13, 2023

Related U.S. Application Data
(60) Provisional application No. 63/051,272, filed on Jul. 13, 2020.

(51) Int. Cl. H04W 24/08; H04W 76/19; H04W 74/08

(52) U.S. Cl. CPC H04W 24/08; H04W 76/19; H04W 74/0833

(57) ABSTRACT

Apparatuses, methods, and systems are disclosed for Beam Failure Recovery (“BFR”) for multiple active Bandwidth Parts (“BWPs”). One apparatus in a mobile communication network includes a processor and a transceiver that receives a configuration for with a serving cell in a radio access network (“RAN”), where the serving cell is configured with multiple BWPs and where a plurality of said multiple BWPs are activated. The processor detects beam failure for at least one of the multiple active BWPs. In response to detecting the beam failure, the processor controls the transceiver to transmit a signaling message to an entity in the RAN, said message identifying a serving cell identifier and each active BWP experiencing beam failure.

### CROSS-REFERENCE TO RELATED APPLICATIONS

This application claims priority to U.S. Provisional Patent Application No. 63/046,527 entitled “BEAM FAILURE RECOVERY PROCEDURE FOR MULTIPLE ACTIVE BWPS SCENARIOS” and filed on Jul. 13, 2020 for Joachim Loehr, Hyejung Jung, Vijay Nangia, and Ravi Kuchibhotla, which application is incorporated herein by reference.

### FIELD

The subject matter disclosed herein relates generally to wireless communications and more particularly relates to Beam Failure Recovery (“BFR”) procedure for multiple active BWPs scenarios.

### BACKGROUND

In certain wireless communication systems, Multiple-Input and Multiple-Output (“MIMO”) techniques are used to improve data throughput. In Fifth Generation (“5G”) wireless communication systems, massive MIMO may be achieved by using beams-based cell-sector coverage where several narrow-beamwidth beams achieve coverage of the cell-sector in place of the single wide-beam used in previous generations. However, each beam in the massive MIMO system covers a limited area of the cell-sector and so Beam Failure (“BF”) may occur, for example due to User Equipment (“UE”) mobility or environmental conditions (e.g., radio shadow, interference, etc.).

In certain wireless communication systems, a UE may be configured with multiple bandwidth parts (“BWP”) to enable flexibility in how radio resources are assigned in a cell-sector. In 5G New Radio (“NR”), base stations may utilize a wider bandwidth as compared to previous generations. With bandwidth parts, the wideband carrier is subdivided into different frequency sets.

### BRIEF SUMMARY

Disclosed are procedures for Beam Failure Recovery (“BFR”) for multiple active Bandwidth Parts (“BWPs”). Said procedures may be implemented by apparatus, systems, methods, or computer program products.

One method of a User Equipment (“UE”) includes receiving a configuration for a serving cell in a Radio Access Network (“RAN”), where the serving cell is configured with multiple BWPs and where a plurality of said multiple BWPs are activated. The method includes detecting beam failure for at least one of the multiple active BWPs and transmitting a signaling message to an entity in the RAN in response to detecting the beam failure, said message identifying a serving cell identity (“ID”) and each active BWP experiencing beam failure.

One method of a RAN node includes configuring a remote unit (e.g., a UE) with multiple BWPs and communicating with the remote unit using multiple active BWPs. The second method includes receiving a signaling message from the remote unit in response to the remote unit detecting beam failure for at least one of the multiple active BWPs. Here, the received message identifies a serving cell ID and each active BWP experiencing beam failure.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for BFR procedure for multiple active BWPs;

FIG. 2 is a block diagram illustrating one embodiment of a 5G New Radio (“NR”) protocol stack;

FIG. 3A depicts a signal flow diagram illustrating one embodiment of Special Cell (“SpCell”) Beam Failure Recovery (“BFR”) procedure;

FIG. 3B depicts a signal flow diagram illustrating one embodiment of Secondary Cell (“SCell”) BFR procedure;

FIG. 4A depicts a diagram illustrating one embodiment of a SCell BFR MAC control element (“CE”);

FIG. 4B depicts a diagram illustrating another embodiment of a SCell BFR MACCE;

FIG. 5 depicts a diagram illustrating one embodiment of a beam failure recovery configuration information element;

FIG. 6 is a block diagram illustrating one embodiment of a user equipment apparatus that may be used for BFR procedure for multiple active BWPs;

FIG. 7 is a block diagram illustrating one embodiment of a network equipment apparatus that may be used for BFR procedure for multiple active BWPs;

FIG. 8 is a block diagram illustrating one embodiment of a first method for BFR procedure for multiple active BWPs; and

FIG. 9 is a block diagram illustrating one embodiment of a second method for BFR procedure for multiple active BWPs.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for efficient BFR procedure for multiple active BWPs. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

To support various requirements of different services (at least including enhanced mobile broadband (“eMBB”), ultra-reliable low-latency communications (“URLLC”), massive machine type communication (“mMTC”)), 5G/NR is envisioned to support different Orthogonal Frequency Division Multiplexing (“OFDM”) numerologies, i.e., sub-carrier spacing (“SCS”), Cyclic Prefix (“CP”) length, in a single framework. However, the various use cases/deployment scenarios for NR have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced.

On the other hand, in case of URLLC, the tighter requirements are put on ultra-low latency (e.g., 0.5 ms each for uplink (“UL”) and downlink (“DL”) for user plane latency) and high reliability (1-10⁻⁵ within 1 ms). Finally, mMTC requires high connection density, large coverage in harsh environments, and extremely long-life battery for low cost devices. Therefore, the OFDM numerology (e.g., subcarrier spacing, OFDM symbol duration, cyclic prefix (“CP”) duration, number of symbols per scheduling interval) that is suitable for one use case might not work well for another. For example, low-latency services may require a shorter symbol duration (and thus larger subcarrier spacing) and/or fewer symbols per scheduling interval (aka, TTI) than an mMTC service.

Furthermore, deployment scenarios with large channel delay spreads require a longer CP duration than scenarios with short delay spreads. The subcarrier spacing should be optimized accordingly to retain the similar CP overhead. It was agreed to study different numerologies across different carrier(s) for a given UE as well as different numerologies within the same carrier for a given UE, i.e., different OFDM numerologies are multiplexed in frequency-domain and/or time-domain within the same carrier or across different carriers. This benefits simultaneous support of services with vastly different requirements, e.g., ultra-low latency communications (short symbols and thus wide subcarrier spacing) and MBMS services (long symbols to enable long cyclic prefix and thus narrow subcarrier spacing).

To enable Bandwidth adaption, i.e., adapting the size of the bandwidth used for data transmission in a serving cell, on the PCell, the gNB configures the UE with UL and DL Bandwidth Part(s) (BWP). To enable bandwidth adaptation on S Cells for the case of carrier aggregation, the gNB at least configures the UE with DL BWP(s) (i.e., there may be no BWP in the UL).

In paired spectrum, DL and UL can switch BWP independently. In unpaired spectrum, DL and UL switch BWP simultaneously. Switching between configured BWPs happens by means of a DCI, i.e., PDCCH indicating to switch to another Bandwidth part, or inactivity timer. When an inactivity timer is configured for a serving cell, the expiry of the inactivity timer associated to that cell switches the active BWP to a default BWP configured by the network.

For an activated Serving Cell, there is always one active BWP at any point in time. The BWP switching for a Serving Cell is used to activate an inactive BWP and/or deactivate an active BWP, and is controlled by the PDCCH indicating a downlink assignment or an uplink grant. Upon addition of SpCell or activation of an SCell, one BWP is initially active without receiving PDCCH indicating a downlink assignment or an uplink grant.

According to Release 16 of the 3GPP specifications (“Rel-16”), only one active BWP at a time. BWPs configured with different configurations can be applied to accommodate different service requirements. For example, when UE supports services requiring different numerologies, gNB needs to switch between different configured BWP(s). In order to support Quality-of-Service (“QoS”) more efficiently, in particular for scenarios where a UE has services/radio bearer running requiring different QoS, it is envisioned that it will be possible to have multiple BWP(s) activated simultaneously in future releases. Furthermore, different BWPs of a serving cell may be also associated with different Transmission/reception points (“TRPs”).

Problem 1: The current Rel-16 standard only supports beam failure detection and recovery being operated on a serving cell level, i.e., beam failure is detected for a serving cell. Assuming that a UE may in future support multiple active DL/UL BWPs in a serving cell, it may be the case that a beam failure occurs on one BWP whereas other BWP(s) in the same cell do not experience any link problem (beam failure is not detected for other BWP(s) in the serving cell). In particular for deployments where different BWPs of a cell are associated with different TRPs, such case may happen. Also in scenarios, where the channel bandwidth of a cell is large, e.g., spanning several hundreds of MHz, and different BWPs may be located far apart from each other, i.e., at the edge of the channel bandwidth, the radio channel conditions, e.g., interference situation, of the different BWPs are uncorrelated such that beam failure events also may be occurring independent for each of the serving cell's BWPs. For such cases, the gNB needs to know which of the active BWP(s) of a serving cell experienced a beam failure in order to execute the correct countermeasures, i.e. changing the serving beam. However current mechanism only allows to indicate the serving cell for which a Beam Failure (“BF”) was detected and not the BWP itself.

In some embodiments, the UE may address the first problem by indicating the serving cell index of a serving for which beam failure was detected on at least one of the multiple active BWPs. The drawback of such procedure would be, that in case only a subset of the active DL BWPs is experiencing a beam failure, e.g., beam failure is detected on one of the active BWPs, the gNB is not aware of whether all of the BWPs were experiencing a beam failure or which of the subset of BWPs detected a beam failure. Therefore, in particular for deployment cases where different BWPs of a cell are associated with different TRPs, the gNB does not know for which BWP to change the serving beam.

Problem 2: For cases when a beam failure occurs on a SpCell, UE triggers according to the current Rel-16 standard a random access procedure in order to notify the gNB about some candidate beams suitable for recovery. In a scenario where UE has multiple active DL/UL BWP(s) on a SpCell, it may be the case though, that not all of the active DL BWPs are experiencing a beam failure (at the same time), but only a subset of them. In other words, the UE has still at least one active BWP in the SpCell where the radio link conditions are good, i.e., communication with gNB is still possible on the SpCell. Performing a random access procedure for such cases, may lead some to inefficient beam failure recovery procedure with an increased signaling overhead and latency.

In some embodiments, the UE may address the second problem, i.e., when the UE is detecting beam failure for a SpCell, by also performing a random access procedure (also referred to as “RACH procedure”) for cases when there is at least one BWP in the SpCell which is not experiencing a beam failure. However, since the UE has still at least one active DL BWP with good radio link conditions, performing the RACH procedure would lead to some inefficient beam failure recovery procedure with an increased signaling overhead and latency.

Disclosed are procedures for supporting BFR procedure for multiple active BWPs scenarios. In certain embodiments, the UE indicates to the gNB, the identity of a serving cell's BWP on which a beam failure was detected. A new MAC CE is introduced, which may contain the serving cell ID and the ID(s) of the BWP(s) for which a beam failure was detected. Optionally also some candidate beam information is included.

Regarding Beam Failure detection/recovery procedure for SCells, the UE triggers the transmission of new BFR MAC CE only for cases when UE has multiple active BWPs for a serving cell and not all these active BWPs are experiencing a beam failure, i.e., there is at least one (DL) BWP in the cell which does not experience a beam failure. For cases when all active BWPs of a cell are experiencing a beam failure or there is only one active BWP for this cell, the UE triggers the transmission of the legacy Rel-16 SCell BFR MAC CE, i.e., indicating beam failure on a serving cell level.

Regarding Beam failure detection/recovery procedure for SpCell, if a beam failure was detected for a BWP in a SpCell (i.e., PCell or PSCell) for cases when the UE has simultaneously multiple (DL) BWPs active/activated in the SpCell and at least one of the active DL BWPs does not experience a beam failure, UE triggers MAC CE transmission indicating the BWP index(es) of the BWPs for which a beam failure was detected. For cases when the UE detects a beam failure on a BWP of a SpCell and there is only one BWP active in the SpCell or all of the active BWP(s) in the SpCell experience a Beam failure, the UE triggers a random access procedure on the SpCell for the SpCell beam failure recovery, e.g., fall back to the Rel-15/16 procedure for SpCell beam failure recovery.

Regarding Beam Failure Detection/Recovery behavior for SpCell, if beam failure is detected on a DL BWP of a SpCell and there is a linked UL BWP which is configured with a BeamFailureRecoveryConfig IE, UE performs the random access procedure for the SpCell beam failure recovery on the linked UL BWP. If the linked UL BWP is currently deactivated, the UE may autonomously switch to and/or activate the linked UL BWP and perform the random access procedure.

If UE detects a beam failure on a DL BWP of a SpCell and there is no linked UL BWP or the linked UL BWP is not configured with a BeamFailureRecoveryConfig IE but the UE is configured with BeamFailureRecoverySpCellConfig on the DL BWP and is provided by schedulingRequestIDForSpCellBFR, a configuration for PUCCH transmission with a link recovery request, on a non-linked UL BWP of the SpCell, UE performs beam failure recovery by transmitting the configured (SR) PUCCH on the non-linked UL BWP of the SpCell.

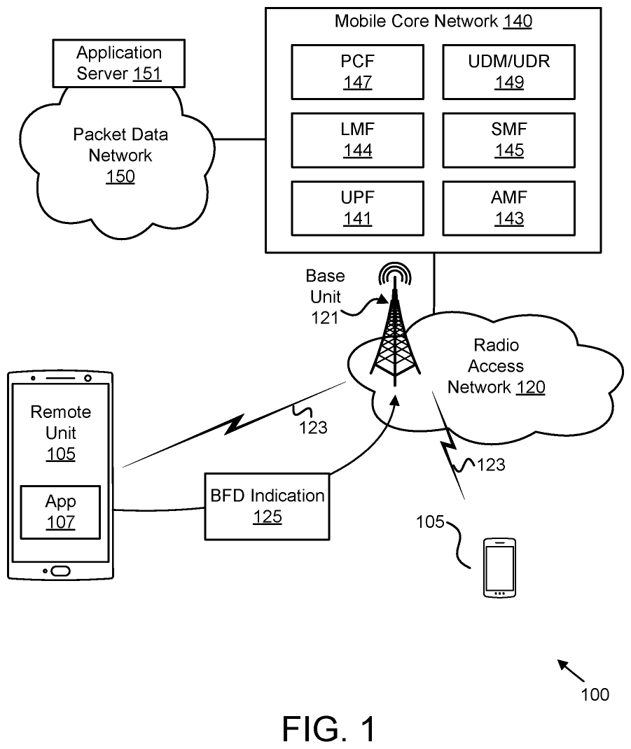

FIG. 1 depicts a wireless communication system 100 for BFR procedure for multiple active BWPs, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140. As described in greater detail below, upon detecting Beam Failure for a serving cell (or cell-sector) the remote unit 105 may send a Beam Failure Detection (“BFD”) indication 125 to a base unit(s) 121. Where the BFD indication 125 initiates or is part of a Beam Failure Recovery (“BFR”) procedure, the BFD indication 125 may be referred to as a BFR indication or BFR message.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for BFR procedure for multiple active BWPs apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the described solutions and procedure are also equally applicable to other mobile communication systems supporting BFR procedure for multiple active BWPs.

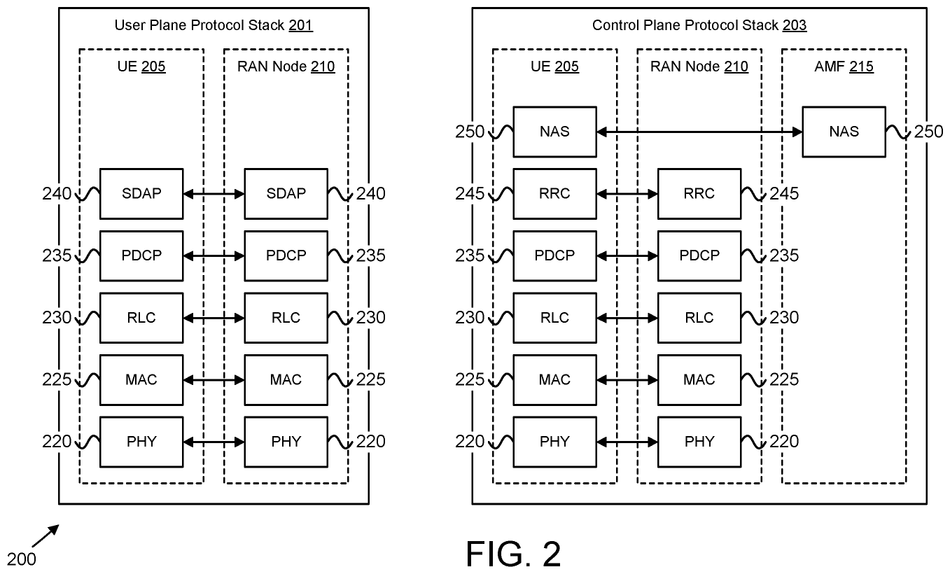

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a beam failure detection procedure using energy detection thresholds, as described herein. In certain embodiments, the physical layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (i.e., RAN node 210) and carries information over the wireless portion of the network.

The MAC layer 225 may be configured by RRC with a beam failure recovery procedure which is used for indicating to the serving RAN node 210 of a new Synchronization Signal Block (“SSB”) or Channel State Information Reference Signal (“CSI-RS”) when beam failure is detected on the serving SSB(s)/CSI-RS(s). A MAC entity at the MAC layer 225 detects beam failure by counting beam failure instance indication from the lower layers (i.e., PHY layer 220) to the MAC entity.

The RRC layer 230 may configure the following parameters for the Beam Failure Detection and Recovery procedure, e.g., in the information elements (“IEs”) beamFailureRecoveryConfig and/or radioLinkMonitoringConfig:
beamFailurelnstanceMaxCount for the beam failure detection
beamFailureDetectionTimer for the beam failure detection
beamFadureRecoveryTimer for the beam failure recovery procedure
rsrp-ThresholdSSB: a Reference Signal Received Power (“RSRP”) threshold for the beam failure recovery
and additional parameters as defined in 3GPP TS 38.321

On the active BWP(s) for each activated Serving Cell with multiple configured BWPs, the MAC entity at the MAC sublayer 225 is to apply normal operations including:
transmit on the Uplink Shared Channel (“UL-SCH”)
transmit on the Random Access Channel (“RACH”)
monitor the Physical Downlink Control Channel (“PDCCH”)
transmit on the Physical Uplink Control Channel (“PUCCH”)
receive on the Downlink Shared Channel (“DL-SCH”)
(re-)initialize any suspended configured uplink grants of configured grant Type 1 according to the stored configuration

On the inactive BWP(s) for each activated Serving Cell with multiple configured BWPs, the MAC entity at the MAC sublayer 225 shall:
not transmit on the UL-SCH
not transmit on the RACH
not monitor the PDCCH
not transmit on the PUCCH
not receive on the DL-SCH
clear any configured downlink assignment and configured uplink grant of configured grant (“CG”) Type 2
suspend any configured uplink grant of CG Type 1

Described below are efficient beam failure detection (“BFD”) and beam failure recovery (“BFR) procedures, with related signaling, which allows the UE 205 to report beam failures on a BWP level and to perform the beam recovery for a BWP for cases where the UE 205 has multiple active BWPs for a serving cell. In particular, for cases where a beam failure occurs only for specific BWP(s) of a SpCell (i.e., where not all active BWPs of the SpCell are experiencing a BF), new UE behavior is disclosed which avoids the usage of a signaling heavy random access procedure thereby also achieving a fast recovery from beam failures for a given BWP.

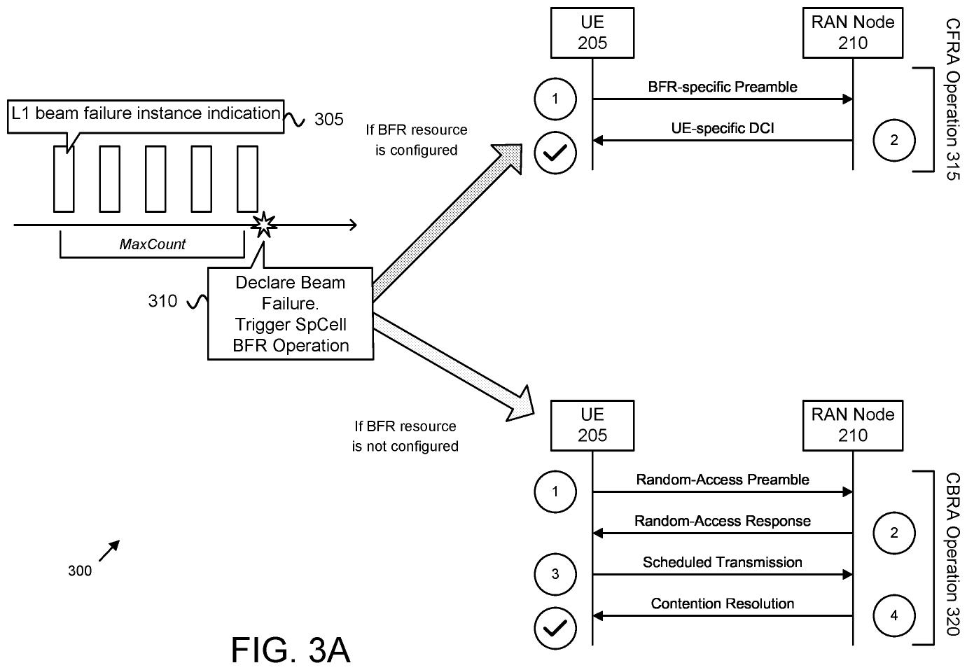

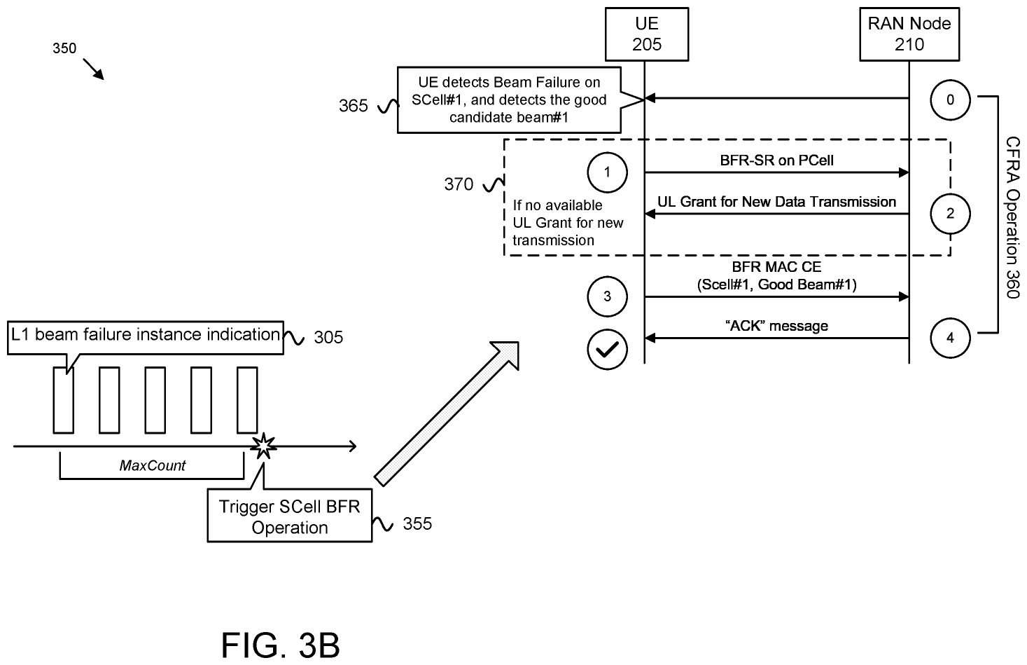

FIG. 3A-3B depict SpCell and SCell beam failure detection and Beam failure recovery operations, according to embodiments of the disclosure.

FIG. 3A depicts one example of a SpCell BFR procedure 300, e.g., performed by a UE 205. For Beam Failure Detection on an SpCell, the UE 205 monitors the quality of the SpCell. Here, the UE 205 tracks instances of L1 beam failure, i.e., where the L1 Reference Signal Received Power (“L1-RSRP”) for the beam goes below a threshold value. When an L1 beam failure instance indication is received at the MAC layer 225, the MAC entity initiates the beamFailureDetectionTimer (if not already running) and increments the beam failure instance count. The UE 205 declares beam failure when the number of beam failure instance indications from the physical layer reaches the configured maximum count (i.e., 5 instances of L1 beam failure in the depicted embodiment) before the configured beamFailureDetectionTimer expires.

Upon declaring beam failure for the SpCell, the UE 205 triggers the SpCell Beam Failure Recovery (“BFR”) operation/procedure (see block 310). Where BFR resource(s) are configured (e.g., by parameter prach-ConfigurationIndex in the beamFailureRecoveryConfig IE), then the UE 205 may initiate a Contention-Free Random-Access (“CFRA”) procedure for BFR and send a BFR-specific preamble on the configured BFR resource(s). The BFR is declared successful when the UE 205 receives a scheduling UL grant (i.e., UE-specific DCI) from the RAN node 210.

Where no BFR resource(s) are configured, the UE 205 may initiate a Contention-Based Random-Access (“CBRA”) procedure for BFR and send a PRACH preamble. In response to receiving Random-Access Response (“RAR”) message (also referred to as “Msg2”) from the RAN node 210, the UE 205 sends a scheduled transmission (also referred to as “Msg3”) on resources scheduled by the Msg3. The BFR is declared successful when the UE 205 receives a contention resolution message (also referred to as “Msg4”) scheduling UL resources from the RAN node 210.

FIG. 3B depicts one example of SCell BFR procedure 350. For Beam Failure Detection on SCell, the UE 205 monitors the quality of an SCell. Here, the UE 205 tracks instances of L1 beam failure, i.e., where the L1 Reference Signal Received Power (“L1-RSRP”) for the beam goes below a threshold value. When an L1 beam failure instance indication is received at the MAC layer 225, the MAC entity initiates the beamFailureDetectionTimer (if not already running) and increments the beam failure instance count. The UE 205 declares beam failure when the number of beam failure instance indications from the physical layer reaches the configured maximum count (i.e., 5 instances of L1 beam failure in the depicted embodiment) before the configured beamFailureDetectionTimer expires.

In case of declaring beam failure, the UE 205 triggers the SCell Beam Failure Recovery (“BFR”) operation/procedure (see block 355). The UE 205 initiates the CFRA Operation 360, which includes detecting a good candidate beam (referred to as “good beam #1”, see block 365) and informs the network (i.e., RAN node 210). Informing the network may include acquiring an UL grant (see block 370), which may be achieved using a Scheduling Request (“SR”) resource on PUCCH for BFR. The BFR SR may be carried on a special cell (“SpCell”), such as the Primary Cell (“PCell”) or a Primary Secondary Cell (“PSCell”).

Using an available UL grant, the UE 205 sends the beam failure recovery request (“BFRQ”) and sends failed SCell index(s) and new beam information (if present) to the network. Additionally, the UE 205 may send a MAC CE providing the network with information about a new beam (if present). Current 3GPP specifications do not restrict MAC CE transmission for BFR, i.e., in Rel-16 the UE 205 can use UL grant of any serving cell for transmission of SCell BFR MAC CE.

According to Release 16 of the 3GPP specifications (“Rel-16”), the UE 205 considers a SCell Beam Failure Recovery procedure successfully completed upon reception of an UL grant scheduling a new transmission for the HARQ process on which SCell BFR MAC CE was sent previously, i.e., thereby acknowledging the reception of the SCell BFR MAC CE.

Table 1 shows the differences between SpCell BFR and SCell BFR procedures.

TABLE 1
Difference between SpCell BFR and SCell BFR procedure

| | SpCell BFR | SCell BFR |
|---|---|---|
| | Procedure | Procedure |
| Candidate | Corresponding SSB/CSI-RS | Indicated in BFR |
| beam | associated to dedicated RA | MAC CE |
| indication | preamble for CFRA or RA preamble | |
| | (SSB) for CBRA. For CBRA a BFR | |
| | MAC CE is included in Msg3 | |
| Transmission | RACH procedure | Any available UL |
| scheme | | grant |
| NW | Not aware if CBRA is used for BFR | Always aware when |
| awareness | | MAC CE received |
| of BFR | | |

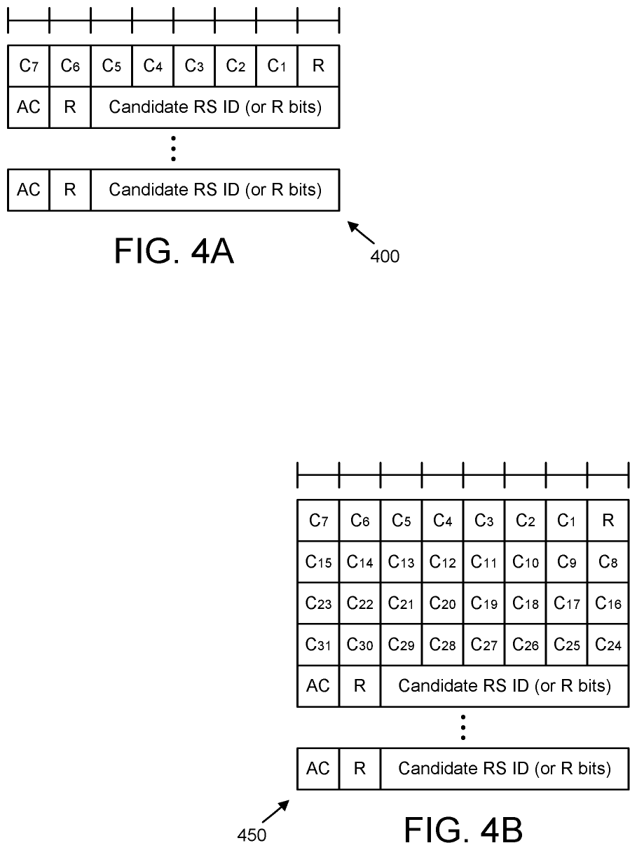

FIGS. 4A and 4B depict examples of SCell BFR MAC CE design. A SCell BFR MAC CE, according to the designs depicted in FIGS. 4A and 4B, may be used to indicate beam failure detection of multiple cells simultaneously. Note that, when cell-level beam failure is detected for SpCell, similar BFR MAC CE may be used to indicate the SpCell.

FIG. 4A shows a first design for a SCell BFR MAC CE 400 for the case of the MAC entity's SCell configured with BFD of less than 8. The BFR MAC CE and Truncated BFR MAC CE has a variable size and may be identified using a MAC subheader with a Logical Channel Identifier (“LCID”) (or enhanced LCID). As depicted, the SCell BFR MAC CE 400 includes a single octet bitmap and, in ascending order based on the ServCellIndex, beam failure recovery information, i.e., octets containing candidate beam availability indication (AC) for the SCells indicated in the bitmap. Here, the single octet bitmap is used to identify the MAC entity's SCell for which beam failure is detected (i.e., from highest ServCellIndex).

The fields in the BFR MAC CE 400 are defined as follows:
Ci: This field indicates beam failure detection for the SCell with ServCellIndex i. The Ci field may be set to ‘1’ to indicate that beam failure is detected and that a corresponding octet containing the AC field for the SCell with ServCellIndex i is present. The Ci field may be set to ‘0’ indicates that the beam failure is not detected and—consequently— no corresponding octet containing the AC field is present for the SCell with ServCellIndex i. The octets containing the AC field, if present, are included in ascending order based on the ServCellIndex. The number of octets containing the AC field included is maximized, while not exceeding the available grant size. Note that the number of the octets containing the AC field in the BFR MAC CE 400 can be zero.
AC: This field indicates the presence of the Candidate RS ID field in this octet. If at least one of the Synchronization Signal Blocks (“SSBs”) with Synchronization Signal RSRP (“SS-RSRP”) above rsrp-ThresholdBFR among the SSBs in candidateBeamRSSCellList or the CSI-RSs with CSI-RSRP above e among the CSI-RSs in candidateBeamRSSCellList is available, the AC field is set to ‘1’; otherwise, it is set to ‘0’. If the AC field set to the Candidate RS ID field is present. If the AC field set to ‘0’, R bits are present instead.
Candidate RS ID: This field is set to the index of an SSB with SS-RSRP above rsrp-ThresholdBFR among the SSBs in candidateBeamRSSCellList or to the index of a CSI-RS with CSI-RSRP above rsrp-ThresholdBFR among the CSI-RSs in candidateBeamRSSCellList. The length of this field is 6 bits.
R: Reserved bit, set to ‘0’.

FIG. 4B shows a second design for a SCell BFR MAC CE 450 for the case of the MAC entity's SCell configured with BFD equal to or higher than 8. The BFR MAC CE 450 has a variable size and may be identified using a MAC subheader with a LCID (or enhanced LCID). As depicted, the BFR MAC CE 450 includes a four-octet bitmap and, in ascending order based on the ServCellIndex, beam failure recovery information, i.e., octets containing candidate beam availability indication (AC) for the SCells indicated in the bitmap. Here, the bitmap uses four octets to indicate the MAC entity's SCell for which beam failure is detected (i.e., from highest ServCellIndex).

The fields in the BFR MAC CE 450 are defined as follows:
Ci: This field indicates beam failure detection and the presence of an octet containing the AC field for the SCell with ServCellIndex i. The Ci field set to ‘1’ indicates that beam failure is detected and the octet containing the AC field is present for the SCell with ServCellIndex i. The Ci field set to ‘0’ indicates that the beam failure is not detected and octet containing the AC field is not present for the SCell with ServCellIndex i. The octets containing the AC field are present in ascending order based on the ServCellIndex.
AC: This field indicates the presence of the Candidate RS ID field in this octet. If at least one of the SSBs with SS-RSRP above rsrp-ThresholdBFR among the SSBs in candidateBeamRSSCellList or the CSI-RSs with CSIRSRP above rsrp-ThresholdBFR among the CSI-RSs in candidateBeamRSSCellList is available, the AC field is set to 1′; otherwise, it is set to ‘0’. If the AC field set to 1′, the Candidate RS ID field is present. If the AC field set to ‘0’, R bits are present instead.
Candidate RS ID: This field is set to the index of an SSB with SS-RSRP above rsrp-ThresholdBFR among the SSBs in candidateBeamRSSCellList or to the index of a CSI-RS with CSI-RSRP above rsrp-ThresholdBFR among the CSI-RSs in candidateBeamRSSCellList. The length of this field is 6 bits.
R: Reserved bit, set to ‘0’.

According to embodiments of a first solution, the UE 205 indicates to the RAN node 210, e.g., a gNB, the identity of a serving cell's BWP on which a beam failure was detected, i.e., a BFR has been triggered for that BWP. It should be noted that the UE 205 may have multiple configured BWP(s), i.e., DL BWPs as well as UL BWPs, where multiple of the configured DL/UL BWPs are simultaneously active/activated within a serving cell.

Furthermore, the UE 205 may operate an independent beam failure detection and recovery procedure for each of a plurality of activated BWPs in a cell. For example, the UE 205 may be configured with a separate set of TCI state(s) with a separate activated TCI state(s) (for PDCCH/PDSCH) per active DL BWP, a separate set of Beam Failure Detection Reference Signals (“BFD-RS”) per active DL BWP, a separate set of DL Reference Signal (“RS”) resources (e.g. SSB/CSI-RS) corresponding to candidate beams per active UL BWP (for SpCell) or per active DL BWP (for SCell), and/or separate one or more Sounding Reference Signal (“SRS”) resource sets per active UL BWP.

In one example, the threshold Q_{out_LR} against which the quality of a BFD-RS in an active DL BWP is compared may be different for different active DL BWP, e.g., the threshold Q_{out_LR}, which maps to X % Block Error Rate (“BLER”) of a hypothetical PDCCH, X₁% BLER for a first DL BWP and X₂% BLER for a second DL BWP, e.g., due to different service requirements on different BWPs. Because Rel-16 allows only one active BWP at a time per serving cell, currently the beam failure detection and recovery procedure is also performed only per serving cell.

According to one implementation of the first solution, the UE 205 informs the RAN node 210 about a detected beam failure on a serving cell's BWP by means of a MAC control element (“CE”), which may have a variable size. In some embodiments, the MAC CE includes information on the BWPIndex for a serving cell and includes candidate beam indication for BWP(s) indicated in the MAC CE.

In certain embodiments, the MAC CE may contain a bitmap in ascending order based on the BWPIndex for each serving cell, each bit field of the bitmap indicating both A) beam failure detection and B) the presence of a field containing the candidate beam availability indication for the BWP with BWPIndex i of the serving cell (with beam failure detection indicated in bit field i the bitmap). If the field of the bitmap is set to ‘1’, beam failure is detected and the field containing the candidate beam indication is present for the BWP with BWPIndex i. If the field set to ‘0’, the beam failure is not detected, and the candidate beam indication field is not present for the BWP with BWPIndex i.

According to another implementation of the first solution, the UE 205 informs the RAN node 210 whether beam failure was detected for all active BWPs of a serving cell or only for a subset of the active BWPs. According to one specific implementation, a new MAC CE is used to inform the RAN node 210 about the identity of a serving cell's BWP on which a beam failure was detected and, potentially, some beam candidate information.

In some embodiments, the new MAC CE contains the serving cell ID and the identity of each active BWP for which a beam failure was detected. Optionally, the new MAC CE may also include some candidate beam information for each BWP for which beam failure is detected. In certain embodiments, a separate Scheduling Request (“SR”) configuration may be associated with such new MAC CE, e.g., one SR configuration for the legacy SCell BFR MAC CE (i.e., indicating cell-level BFD) and a separate SR configuration for the new MAC CE indicating the identity of a BWP as well as candidate beam information.

In various embodiments, the UE 205 triggers the transmission of such new BFR MAC CE only for cases where 1) the UE 205 has multiple active BWPs for a serving cell and 2) not all these active BWPs are experiencing a beam failure, i.e., there is at least one (DL) BWP in the cell which does not experience a beam failure. For cases where all active BWPs of a cell are experiencing a beam failure or there is only one active BWP for this cell, the UE 205 triggers the transmission of the legacy Rel-16 SCell BFR MAC CE, i.e., indicating beam failure on a serving cell level.

According to another embodiment of the first solution, the UE 205 triggers a Beam failure Recovery (“BFR”) procedure for cases where a beam failure was detected for a BWP of a SCell, e.g., the value of the counter for beam failure instance indication maintained for this BWP is equal to or larger than a predefined threshold (BFI_COUNTER>=beamFailureInstanceMaxCount). In response to triggering a BFR for the BWP, UE sends a message to the RAN node 210 indicating the BWPindex of the BWP for which a beam failure was detected and potentially some candidate beam information. According to one implementation the beam failure information, i.e., BWPindex of BWP for which a beam failure was detected and optionally some candidate beam information, is signaled within a MAC CE.

According to a further embodiment, the UE 205 triggers a BFR procedure when a beam failure was detected for a BWP in a SpCell (i.e., PCell or PSCell) for cases where the UE 205 has multiple (DL) BWPs simultaneously active/activated in the SpCell and where at least one of the active DL BWPs does not experience a beam failure. In response to triggering a BFR for the BWP of the SpCell, the UE 205 sends a message to the RAN node 210 indicating the BWPindex of BWP for which a beam failure was detected and potentially some candidate beam information.

According to one implementation of the first solution, the beam failure information (i.e., BWPindex of BWP for which a beam failure was detected and optionally some candidate beam information) is signaled within a MAC CE, such as the new BFR MAC CE described above. For cases where the UE 205 detects a beam failure on a BWP of a SpCell and there is only one BWP active in the SpCell or all of the active BWP(s) in the SpCell experience a Beam failure, the UE 205 triggers a random access procedure (RACH procedure) on the SpCell for the SpCell beam failure recovery, e.g., falling back to the Rel-15/16 procedure for SpCell beam failure recovery.

According to embodiments of a second solution, the UE 205 may be configured with linked UL and DL BWP. The term “linked” UL BWP may in the context of this embodiment refer to the UL BWP with the same bwp-Id (i.e., as the DL BWP) or alternatively to the UL BWP which is scheduled by DL BWP for which a beam failure was detected.

According to one embodiment of the second solution, the UE 205 ignores received uplink grants allocating uplink resources on a UL BWP which is the linked UL BWP to a DL BWP for which Beam Failure was detected/declared or for which a Beam Failure Recovery procedure was initiated and not successfully completed. According to one implementation of the second solution, the UE 205 autonomously deactivates or clears any configured uplink grants and may also clear any PUSCH resources for semi-persistent CSI reporting for the linked UL BWP of a DL BWP for which beam failure was detected or Beam Failure Recovery procedure was initiated. The UE may also stop transmission on PUCCH if the UL BWP of the SCell is configured with PUCCH, and SRS transmission except possibly for SRS in a resource set with usage set to ‘beamManagement.’

In one implementation of the second embodiment, the UE 205 (e.g., a MAC entity of the UE) stops uplink transmissions for a UL BWP of a SCell upon initiating Beam Failure Recovery procedure for the linked DL BWP. By stopping UL transmissions on the UL BWP of a S Cell for which the Beam Failure Recovery procedure was initiated for the linked DL BWP—and thereby ensuring not to transmit the BFR MAC CE on a UL BWP for which the linked DL BWP was experiencing a Beam Failure—a transmission failure of the BFR MAC CE and, consequently, delayed Beam Failure Recovery procedure is avoided.

According to another embodiment of the second solution, for cases where the UE 205 detects a beam failure on a DL BWP of a SpCell and there is a linked UL BWP, e.g., UL BWP with the same bwp-Id for the SpCell, which is also configured with a BeamFailureRecoveryConfig IE, the UE 205 performs the random access procedure (RACH procedure) for the SpCell beam failure recovery on the linked UL BWP. If the linked UL BWP is currently deactivated, then the UE 205 may autonomously switch to/activate the linked UL BWP and perform the random access procedure. By using the linked UL BWP for the random access procedure, the RAN node 210 is implicitly made aware of the DL BWP for which a beam failure was detected.

According to embodiments of a third solution, the UE 205 is not configured with a UL BWP linked to and DL BWP. As discussed above, the term “linked” UL BWP refers to the UL BWP with the same bwp-Id (as the DL BWP) or alternatively to the UL BWP which is scheduled by DL BWP for which a beam failure was detected.

According to one embodiment of the third solution, for cases where the UE 205 detects a beam failure on a DL BWP of a SpCell and there is no linked UL BWP (i.e., there is no UL BWP with the same bwp-Id for the SpCell) the UE 205 performs the random access procedure for the SpCell beam failure recovery on a UL BWP of the SpCell in which the information element (“IE”) BeamFailureRecoveryConfig is provided (e.g., lowest UL BWP index in case of multiple UL BWP with BeamFailureRecoveryConfig provided). This embodiment also applies to cases where there is a linked UL BWP, but the linked UL BWP is not configured with the BeamFailureRecoveryConfig IE.

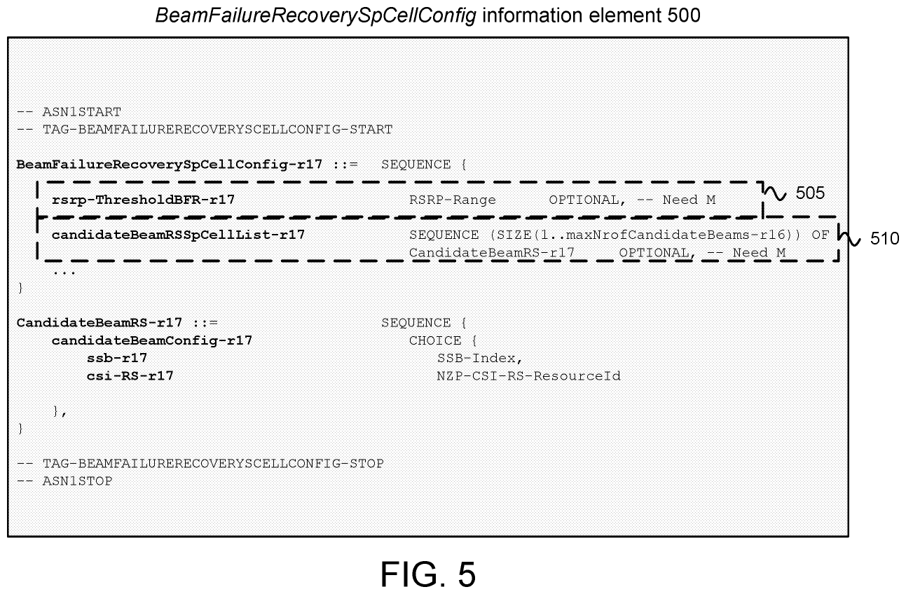

According to another embodiment of the third solution, for cases where the UE 205 detects a beam failure on a DL BWP of a SpCell and there is no linked UL BWP, i.e., UL BWP with the same bwp-Id for the SpCell (i.e., PCell or PSCell) or the linked UL BWP is not configured with a BeamFailureRecoveryConfig information element (“IE”), but where the UE 205 is configured with BeamFailureRecoverySpCellConfig IE on the DL BWP and is provided (e.g., by schedulingRequestIDForSpCellBFR IE) a configuration for PUCCH transmission with a link recovery request on a non-linked UL BWP of the SpCell, the UE 205 performs beam failure recovery by transmitting the configured PUCCH, e.g. SR, on the non-linked UL BWP of the SpCell. The UE 205 may transmit in a first PUSCH at least one MAC CE providing an index for a DL BWP of the SpCell with radio link quality worse than Q_{out,LR}, i.e., BWPindex of BWP for which a beam failure was detected, an index q_{new} for a periodic CSI-RS configuration or for a SS/PBCH block provided by higher layers, if any, for the corresponding DL BWP i.e., candidate beam information. An example implementation of the IE BeamFailureRecoverySpCellConfig is shown at FIG. 5.

FIG. 5 depicts one example of Abstract Syntax Notation 1 (“ASN.1”) description for a BeamFailureRecoverySpCellConfig information element 500, according to embodiments of the disclosure. The BeamFailureRecoverySpCellConfig information element 500 includes a Reference Signal Received Power (“RSRP”) range 505 and a candidateBeamRSList 510.

According to embodiments of a fourth solution, the RAN node 210 may configure reference signals corresponding to candidate beams to be within the DL BWP where beam failure detection and recovery procedure is performed. The UE 205 may provide candidate beam information for recovery based on measurements of reference signals (CSI-RS and/or SSB) which are within the DL BWP for which a beam failure was detected.

The UE 205 may select one of the SSBs with SS-RSRP above a configured threshold among the SSBs in candidateBeamRSList which are within the DL BWP for which beam failure was detected or the CSI-RSs with CSI-RSRP above a threshold among the CSI-RSs in candidateBeamRSList which are within the DL BWP. The UE 205 would consequently use a RACH preamble for the random access procedure with the PREAMBLE_INDEX set to ra-PreambleIndex corresponding to the selected SSB/CSI-RS. For cases where the UE 205 does not find beam candidates within the DL BWP for which a beam failure was detected, e.g., SS-RSRP/CSI-RSRP below the threshold, the UE 205 may also provide candidate beams which are outside the DL BWP.

According to embodiments of a fifth solution, a mapping between a BWP ID and a RACH Occasion (“RO”) and/or Random Access Preamble(s) is introduced when performing random access procedure for SpCell beam failure recovery in order to indicate to the RAN node 210 which DL BWP was experiencing the beam failure.

According to embodiments of a sixth solution, the UE 205 may receive a list for which a TCI States Activation/Deactivation for UE-specific PDSCH MAC CE is applied.

According to one embodiment of the sixth solution, a UE 205 may receive a BWP list (i.e., indication of a plurality of DL BWPs, e.g., a list of BWP indices) for which a common TCI state (e.g., beam) is applied for at least PDSCH and PDCCH (e.g., DL data and control e.g., for intra-band CA). The common TCI state for UE-specific PDCCH and for UE-specific PDSCH may be updated e.g., based on dynamic control signaling (L1) or higher layer signaling to achieve efficient (lower latency and overhead) beam management.

In some examples, a common TCI state may further be applied to be used for DL and UL for the indicated BWP list, e.g., with beam correspondence. Beam correspondence may mean each transmit (“Tx”) port can be beamformed in a desirable direction but does not imply setting phase across ports.

A Transmission-Reception Point (“TRP”) is a transmission point of a gNB. Note that the gNB contains one or more TRP. The TRP is able to determine a TRP Tx beam for the downlink transmission based on TRP's uplink measurement on TRP's one or more Receive (“Rx”) beams. The TRP is able to determine a TRP Rx beam for the uplink reception based on UE's downlink measurement on TRP's one or more Tx beams. In some examples, Transmit/Receive (“Tx/Rx”) beam correspondence at gNB/TRP holds if at least one of the following is satisfied:
TRP is able to determine a TRP Rx beam for the uplink reception based on UE's downlink measurement on TRP's one or more Tx beams; and
TRP is able to determine a TRP Tx beam for the downlink transmission based on TRP's uplink measurement on TRP's one or more Rx beams

The UE 205 is able to determine a UE Tx beam for the uplink transmission based on UE's downlink measurement on UE's one or more Rx beams. The UE 205 is able to determine a UE Rx beam for the downlink reception based on TRP's indication based on uplink measurement on UE's one or more Tx beams. The Tx/Rx beam correspondence at the UE 205 holds if at least one of the following is satisfied:
The UE 205 is able to determine a UE Tx beam for the uplink transmission based on UE's downlink measurement on UE's one or more Rx beams; and
The UE 205 is able to determine a UE Rx beam for the downlink reception based on TRP's indication based on uplink measurement on UE's one or more Tx beams

According to another embodiment of the sixth solution, a UE 205 may receive a CORESET list (i.e., indication of a plurality of CORESETs, e.g., a list of CORESET IDs e.g., corresponding to a CORESET pool or group), to which a TCI state indication for UE-specific PDCCH MAC CE is applied.

In one implementation, the BWP list and/or the CORESET list are configured for a UE 205 that is capable of multiple active BWP operation and is indicated with multiple active BWP operation.

In some of the embodiments described, a TCI state associated with a target transmission can indicate parameters for configuring a Quasi-Co-Location (“QCL”) relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The UE 205 may receive a configuration of a plurality of transmission configuration indicator states for a serving cell for transmissions on the serving cell.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter/beam used for reception the reference RS (e.g., DL RS such as SSB/CSI-RS). In another example, the device may transmit the target transmission with the same spatial domain transmission filter/beam used for the transmission of the reference RS (e.g., UL RS such as SRS). A device can receive a configuration of a plurality of spatial relation information configurations for a serving cell for transmissions on the serving cell.

In some of the embodiments described, an antenna port is defined such that the channel over which a symbol on the antenna port is conveyed can be inferred from the channel over which another symbol on the same antenna port is conveyed.

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (“CDD”). The procedure used to derive antenna ports from physical antennas may be specific to a device implementation and transparent to other devices.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

Two antenna ports may be quasi-located with respect to a subset of the large-scale properties and different subset of large-scale properties may be indicated by a QCL Type. For example, the parameter qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (“AoA”), Dominant AoA, average AoA, angular spread, Power Angular Spectrum (“PAS”) of AoA, average angle of departure (“AoD”), PAS of AoD, transmit/receive channel correlation, transmit/receive beamforming, spatial channel correlation etc.

In some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to the RAN node. For certain condition(s), the RAN node 210 can assume the mapping between device's physical antennas to the logical entity “device panel” may not be changed. For example, the condition may include until the next update or report from device or comprise a duration of time over which the RAN node assumes there will be no change to the mapping.

A Device may report its capability with respect to the “device panel” to the RAN node or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

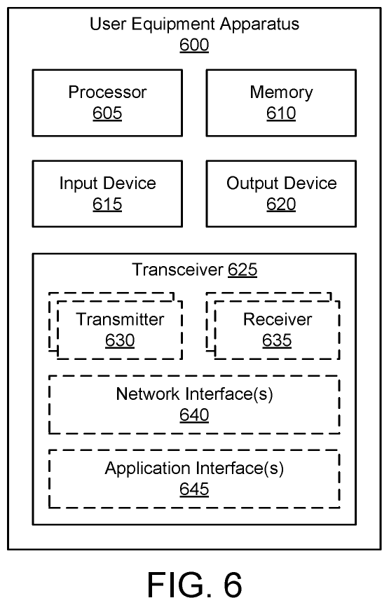

FIG. 6 depicts a user equipment apparatus 600 that may be used for BFR procedure for multiple active BWPs, according to embodiments of the disclosure. In various embodiments, the user equipment apparatus 600 is used to implement one or more of the solutions described above. The user equipment apparatus 600 may be one embodiment of the remote unit 105 and/or the UE 205, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, the transceiver 625 receives a configuration for a serving cell in a RAN, where the serving cell is configured with multiple BWPs and where a plurality of the configured multiple BWPs are activated. The processor 605 detects beam failure for at least one of the multiple active BWPs. In response to detecting the beam failure, the processor 605 controls the transceiver 625 to transmit a signaling message to an entity in the RAN (e.g., gNB, TRP), said message identifying a serving cell ID and each active BWP experiencing beam failure.

In some embodiments, at least one of the multiple active BWPs does not experience beam failure. In certain embodiments, the signaling message contains a MAC CE that indicates beam failure on the BWP level, where the MAC CE contains a BWP index for each active BWP experiencing beam failure. In certain embodiments, the transceiver 625 further receives a SR resource configuration for the MAC CE, where the signaling message is transmitted using configured SR resources. In other embodiments, all the multiple active BWPs experience beam failure. In such embodiments, the signaling message may contain a BFR MAC CE that indicates beam failure on the serving cell level. In certain embodiments, the processor 605 performs a random access procedure for beam failure recovery when all the multiple active BWPs experience beam failure.

In some embodiments, the signaling message additionally contains candidate beam information for each active BWP experiencing beam failure. In some embodiments, the serving cell is a SpCell (i.e., a PCell or PSCell). In other embodiments, the serving cell is a SCell.

In some embodiments, the beam failure is detected for a DL BWP having a linked UL BWP. In such embodiments, the processor 605 performs beam failure recovery for the DL BWP by performing a random-access procedure for beam failure recovery using the linked UL BWP. In certain embodiments, the linked UL BWP is deactivated when the beam failure is detected. In further embodiments, the processor 605 autonomously activates the linked UL BWP in response to detecting beam failure for the linked DL BWP. In certain embodiments, the processor 605 autonomously clears a configured grant on the linked UL BWP in response to detecting beam failure for the linked DL BWP.

In some embodiments, the transceiver 625 further receives a configuration for at least one of: a separate active Transmission Configuration Indicator (“TCI”) per active DL BWP, a separate set of BFD-RS per active DL BWP, a separate set of DL Reference Signal (“RS”) resources (e.g., Synchronization Signal Block (“SSB”) or Channel State Information RS (“CSI-RS”)) corresponding to candidate beams per active BWP (e.g., UL BWP for SpCell and/or DL BWP for SCell), and separate one or more Sounding Reference Signal (“SRS”) resource sets per active UL BWP. In some embodiments, the transceiver 625 further receives a scheduling request (“SR”) resource configuration for the MAC CE. In such embodiments, the signaling message may be transmitted on configured SR resources.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to BFR procedure for multiple active BWPs. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

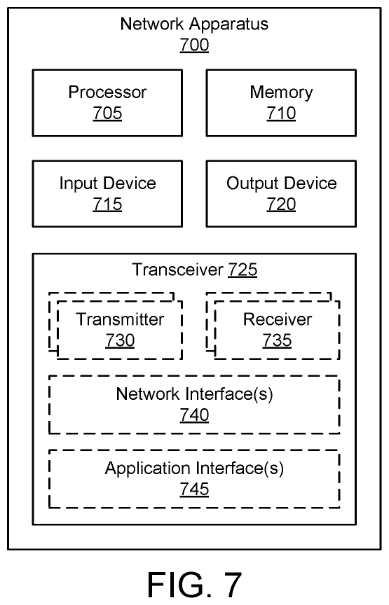

FIG. 7 depicts a network apparatus 700 that may be used for BFR procedure for multiple active BWPs, according to embodiments of the disclosure. In one embodiment, network apparatus 700 may be one implementation of a RAN node, such as the base unit 121 and/or the RAN node 210, as described above. Furthermore, the base network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 75. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the processor 705 controls the transceiver 725 to configure a UE with multiple BWPs and communicates with the UE using multiple active BWPs. Here, the configured multiple BWPs include a plurality of DL BWPs and a plurality of UL BWPs. Via the transceiver 725, the processor 705 receives a signaling message from the UE in response to the UE detecting beam failure for at least one of the multiple active BWPs. Here, the received message identified a serving cell ID and each active BWP experiencing beam failure.

In some embodiments, the received signaling message contains a MAC CE that indicates beam failure on the BWP level, where the MAC CE contains a BWP index for each active BWP experiencing beam failure. In other embodiments, the signaling message is a BFR MAC CE that indicates beam failure on the serving cell level.

In some embodiments, the signaling message additionally contains candidate beam information for each active BWP experiencing beam failure. In some embodiments, the serving cell is a SpCell (i.e., a PCell or PSCell). In other embodiments, the serving cell is a SCell.

In some embodiments, the processor 705 configures the UE with at least one of: a separate active TCI per active DL BWP, a separate set of BFD-RS per active DL BWP, a separate set of DL RS resources (e.g., SSB/CSI-RS) corresponding to candidate beams per active BWP (e.g., UL BWP for SpCell or DL BWP for SCell), and separate one or more SRS resource sets per active UL BWP.

In certain embodiments, the processor 705 further configures the UE with a SR resource configuration for the MAC CE, where the signaling message is received on configured SR resources. In certain embodiments, the MAC CE indicates that the UE does not experience beam failure on at least one of the multiple active BWPs.

In some embodiments, the transceiver 725 receives a Random-Access message (i.e., a PRACH preamble or first message of a RACH procedure) in response to the UE experiencing beam failure on all active BWPs in the serving cell. In some embodiments, the transceiver 725 further receives a Random-Access message on a UL BWP having a linked DL BWP, where the Random-Access message indicates that the UE experiences beam failure at the linked a DL BWP.

In some embodiments, the signaling message additionally contains candidate beam information for each active BWP experiencing beam failure. In some embodiments, the serving cell is a SpCell (i.e., PCell or PSCell). In such embodiments, the signaling message may be a Random-Access message indicating that the remote unit experiences beam failure on all of the multiple active BWPs of the special cell.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to BFR procedure for multiple active BWPs. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

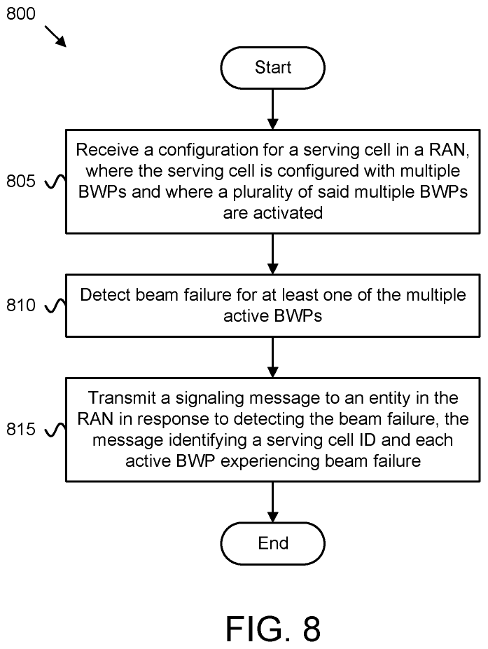

FIG. 8 depicts one embodiment of a method 800 for BFR procedure for multiple active BWPs, according to embodiments of the disclosure. In various embodiments, the method 800 is performed by a user equipment device in a mobile communication network, such as the remote unit 105, the UE 205, and/or the user equipment apparatus 600, described above. In some embodiments, the method 800 is performed by a processor, such as a microcontroller, a microprocessor, a CPU, a GPU, an auxiliary processing unit, a FPGA, or the like.

The method 800 begins and receives 805 a configuration for a serving cell in a RAN, where the serving cell is configured with multiple BWPs and where a plurality of said multiple BWPs are activated. The method 800 includes detecting 810 beam failure for at least one of the multiple active BWPs. The method 800 includes transmitting 815 a signaling message (e.g., MAC CE) to an entity in the RAN in response to detecting the beam failure. Here, the message identifies a serving cell ID and each active BWP experiencing beam failure. The method 800 ends.

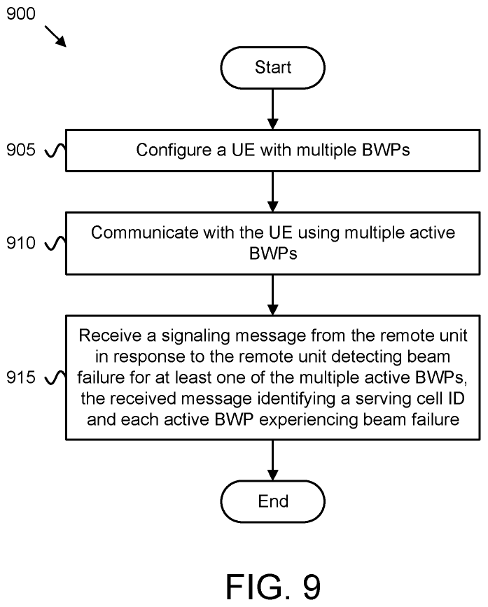

FIG. 9 depicts one embodiment of a method 900 for BFR procedure for multiple active BWPs, according to embodiments of the disclosure. In various embodiments, the method 900 is performed by a radio access network entity in a mobile communication network, such as the base unit 121, the RAN node 210, and/or the network apparatus 700, described above. In some embodiments, the method 900 is performed by a processor, such as a microcontroller, a microprocessor, a CPU, a GPU, an auxiliary processing unit, a FPGA, or the like.

The method 900 begins and configures 905 a UE with multiple BWPs. The method 900 includes communicating 910 with the UE using multiple active BWPs. The method 900 includes receiving 915 a signaling message from the remote unit in response to the remote unit detecting beam failure for at least one of the multiple active BWPs. Here, the received message identifies a serving cell ID and each active BWP experiencing beam failure. The method 900 ends.

Disclosed herein is a first apparatus for BFR procedure for multiple active BWPs, according to embodiments of the disclosure. The first apparatus may be implemented by a user equipment device in a mobile communication network, such as the remote unit 105, the UE 205, and/or the user equipment apparatus 600, described above. The first apparatus includes a processor and a transceiver that is configured with a serving cell in a RAN, where the serving cell is configured with multiple BWPs and where a plurality of said multiple BWPs are activated. The processor detects beam failure for at least one of the multiple active BWPs. In response to detecting the beam failure, the processor controls the transceiver to transmit a signaling message to an entity in the RAN (e.g., gNB, TRP), said message identifying a serving cell ID and each active BWP experiencing beam failure.

In some embodiments, at least one of the multiple active BWPs does not experience beam failure. In certain embodiments, the signaling message is a MAC CE that indicates a BWP index for each active BWP experiencing beam failure. In some embodiments, all the multiple active BWPs experience beam failure. In such embodiments, the signaling message may be a BFR MAC CE that indicates beam failure on the serving cell level. In certain embodiments, the processor performs a random access procedure for beam failure recovery when all the multiple active BWPs experience beam failure.

In some embodiments, the signaling message additionally contains candidate beam information for each active BWP experiencing beam failure. In some embodiments, the serving cell is a SpCell (i.e., a PCell or PSCell). In other embodiments, the serving cell is a SCell.

In some embodiments, the beam failure is detected for a DL BWP having a linked UL BWP. In such embodiments, the processor performs beam failure recovery for the DL BWP by performing a random-access procedure for beam failure recovery using the linked UL BWP. In certain embodiments, the linked UL BWP is deactivated when the beam failure is detected. In further embodiments, the processor autonomously activates the linked UL BWP in response to detecting beam failure for the linked DL BWP. In certain embodiments, the linked UL BWP is activated when the beam failure is detected. In further embodiments, the processor autonomously clears a configured grant on the linked UL BWP in response to detecting beam failure for the linked DL BWP.

In some embodiments, the transceiver further receives a configuration for at least one of: a separate active TCI per active DL BWP, a separate set of BFD-RS per active DL BWP, a separate set of DL RS resources (e.g., SSB/CSI-RS) corresponding to candidate beams per active BWP (e.g., UL BWP for SpCell and/or DL BWP for SCell), and separate one or more SRS resource sets per active UL BWP. In some embodiments, the transceiver further receives a SR resource configuration for the MAC CE. In such embodiments, the signaling message may be transmitted on configured SR resources.

Disclosed herein is a first method for BFR procedure for multiple active BWPs, according to embodiments of the disclosure. The first method may be performed by a user equipment device in a mobile communication network, such as the remote unit 105, the UE 205, and/or the user equipment apparatus 600, described above. The first method includes receiving a configuration for a serving cell in a RAN, where the serving cell is configured with multiple BWPs and where a plurality of said multiple BWPs are activated. The first method includes detecting beam failure for at least one of the multiple active BWPs and transmitting a signaling message to an entity in the RAN (e.g., gNB) in response to detecting the beam failure, said message identifying a serving cell ID and each active BWP experiencing beam failure.

In some embodiments, at least one of the multiple active BWPs does not experience beam failure. In certain embodiments, the signaling message is a MAC CE that indicates a BWP index for each active BWP experiencing beam failure. In some embodiments, all the multiple active BWPs experience beam failure. In such embodiments, the signaling message may be a BFR MAC CE that indicates beam failure on the serving cell level. In certain embodiments, the first method performs a random access procedure for beam failure recovery when all the multiple active BWPs experience beam failure.

In some embodiments, the signaling message additionally contains candidate beam information for each active BWP experiencing beam failure. In some embodiments, the serving cell is a SpCell (i.e., a PCell or PSCell). In other embodiments, the serving cell is a SCell.

In some embodiments, the beam failure is detected for a DL BWP having a linked UL BWP. In such embodiments, the first method performs beam failure recovery for the DL BWP by performing a random-access procedure for beam failure recovery using the linked UL BWP. In certain embodiments, the linked UL BWP is deactivated when the beam failure is detected. In further embodiments, the first method includes autonomously activating the linked UL BWP in response to detecting beam failure for the linked DL BWP. In certain embodiments, the linked UL BWP is activated when the beam failure is detected. In further embodiments, the first method includes autonomously clearing a configured grant on the linked UL BWP in response to detecting beam failure for the linked DL BWP.

In some embodiments, the first method includes receiving a configuration for at least one of: a separate active TCI per active DL BWP, a separate set of BFD-RS per active DL BWP, a separate set of DL RS resources (e.g., SSB/CSI-RS) corresponding to candidate beams per active BWP (e.g., UL BWP for SpCell and/or DL BWP for SCell), and separate one or more SRS resource sets per active UL BWP. In some embodiments, the first method includes receiving a SR resource configuration for the MAC CE. In such embodiments, the signaling message may be transmitted on configured SR resources.

Disclosed herein is a second apparatus for BFR procedure for multiple active BWPs, according to embodiments of the disclosure. The second apparatus may be implemented by a radio access network entity in a mobile communication network, such as the base unit 121, the RAN node 210, and/or the network apparatus 700, described above. The second apparatus includes a processor that configures a remote unit (e.g., a UE) with multiple BWPs and a transceiver that communicates with the remote unit using multiple active BWPs. Here, the configured multiple BWPs include a plurality of DL BWPs and a plurality of UL BWPs. Via the transceiver, the processor receives a signaling message from the remote unit in response to the remote unit detecting beam failure for at least one of the multiple active BWPs. Here, the received message identified a serving cell ID and each active BWP experiencing beam failure.

In some embodiments, the processor configures the remote unit with at least one of: a separate active TCI per active DL BWP, a separate set of BFD-RS per active DL BWP, a separate set of DL RS resources (e.g., SSB/CSI-RS) corresponding to candidate beams per active BWP (e.g., UL BWP for SpCell or DL BWP for SCell), and separate one or more SRS resource sets per active UL BWP.

In some embodiments, the received signaling message contains a MAC CE that indicates a BWP index for each active BWP experiencing beam failure. In certain embodiments, the processor further configures the remote unit with a SR resource configuration for the MAC CE, where the signaling message is received on configured SR resources. In certain embodiments, the MAC CE indicates that the remote unit does not experience beam failure on at least one of the multiple active BWPs.

In some embodiments, the signaling message contains a BFR MAC CE, where the BFR MAC CE indicates beam failure on the serving cell level. In some embodiments, the transceiver further receives a Random-Access message on a UL BWP having a linked DL BWP, where the Random-Access message indicates that the remote unit experiences beam failure at the linked a DL BWP.

In some embodiments, the signaling message additionally contains candidate beam information for each active BWP experiencing beam failure. In some embodiments, the serving cell is a SpCell (i.e., PCell or PSCell). In such embodiments, the signaling message may be a Random-Access message indicating that the remote unit experiences beam failure on all of the multiple active BWPs of the special cell.

Disclosed herein is a second method for BFR procedure for multiple active BWPs, according to embodiments of the disclosure. The second method may be performed by a radio access network entity in a mobile communication network, such as the base unit 121, the RAN node 210, and/or the network apparatus 700, described above. The second method includes configuring a remote unit (e.g., a UE) with multiple BWPs and communicating with the remote unit using multiple active BWPs. The second method includes receiving a signaling message from the remote unit in response to the remote unit detecting beam failure for at least one of the multiple active BWPs. Here, the received message identifies a serving cell ID and each active BWP experiencing beam failure.

In some embodiments, the second method further includes configuring the remote unit with at least one of: a separate active TCI per active DL BWP, a separate set of BFD-RS per active DL BWP, a separate set of DL RS resources (e.g., SSB/CSI-RS) corresponding to candidate beams per active BWP (e.g., UL BWP for SpCell or DL BWP for SCell), and separate one or more SRS resource sets per active UL BWP.

In some embodiments, the received signaling message contains a MAC CE that indicates a BWP index for each active BWP experiencing beam failure. In certain embodiments, the second method further includes configuring the remote unit with a SR resource configuration for the MAC CE, where the signaling message is received on configured SR resources. In certain embodiments, the MAC CE indicates that the remote unit does not experience beam failure on at least one of the multiple active BWPs.

In some embodiments, the signaling message contains a BFR MAC CE, where the BFR MAC CE indicates beam failure on the serving cell level. In some embodiments, the transceiver further receives a Random-Access message on a UL BWP having a linked DL BWP, where the Random-Access message indicates that the remote unit experiences beam failure at the linked a DL BWP.

In some embodiments, the signaling message additionally contains candidate beam information for each active BWP experiencing beam failure. In some embodiments, the serving cell is a SpCell (i.e., PCell or PSCell). In such embodiments, the signaling message may be a Random-Access message indicating that the remote unit experiences beam failure on all of the multiple active BWPs of the special cell.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A User Equipment (“UE”) apparatus comprising:
a memory; and
a processor coupled to the memory, the processor configured to cause the apparatus to:
receive a configuration for a serving cell in a Radio Access Network (“RAN”), wherein the serving cell is configured with multiple Bandwidth Parts (“BWPs”), wherein a plurality of the multiple BWPs are activated;
detect beam failure for at least one of the multiple active BWPs; and
transmit a signaling message to an entity in the RAN in response to detecting the beam failure, the signaling message identifying a serving cell identity (“ID”) and each active BWP experiencing beam failure.

17. The apparatus of claim 16, wherein at least one of the multiple active BWPs does not experience beam failure, wherein to transmit the signaling message, the processor is configured to cause the processor to transmit a Medium Access Control (“MAC”) Control Element (“CE”), wherein the MAC CE indicates a BWP index for each active BWP experiencing beam failure.

18. The apparatus of claim 16, wherein the signaling message additionally contains candidate beam information for each active BWP experiencing beam failure.

19. The apparatus of claim 16, wherein the serving cell is a special cell, the special cell being one of a Primary Cell (“PCell”) and a Primary Secondary Cell (“PSCell”).

20. The apparatus of claim 19, wherein all the multiple active BWPs experience beam failure, wherein the processor is configured to cause the apparatus to perform beam failure recovery by performing a random access procedure.

21. The apparatus of claim 19, wherein the beam failure is detected for a downlink (“DL”) BWP having a linked uplink (“UL”) BWP, wherein the processor is configured to cause the apparatus to perform beam failure recovery for the DL BWP by performing a random-access procedure for beam failure recovery using the linked UL BWP.

22. The apparatus of claim 21, wherein the processor is configured to:
deactivate the linked UL BWP when the beam failure is detected, and
autonomously activate the linked UL BWP in response to detecting beam failure for the linked DL BWP.

23. The apparatus of claim 21, wherein the processor is configured to:
deactivate the linked UL BWP when the beam failure is detected, and
autonomously clear a configured grant on the linked UL BWP in response to detecting beam failure for the linked DL BWP.

24. The apparatus of claim 16, wherein the serving cell is a secondary cell (“SCell”).

25. The apparatus of claim 24, wherein all the multiple active BWPs experience beam failure, wherein to transmit the signaling message, the processor is configured to cause the apparatus to transmit a Beam Failure Recovery (“BFR”) Medium Access Control (“MAC”) Control Element (“CE”), wherein the BFR MAC CE indicates beam failure on the serving cell level.

26. A method of a User Equipment (“UE”) comprising:
receiving a configuration for a serving cell in a Radio Access Network (“RAN”), wherein the serving cell is configured with multiple Bandwidth Parts (“BWPs”), wherein a plurality of the multiple BWPs are activated;
detecting beam failure for at least one of the multiple active BWPs; and
transmitting a signaling message to an entity in the RAN in response to detecting the beam failure, the signaling message identifying a serving cell identity (“ID”) and each active BWP experiencing beam failure.

27. The method of claim 26, wherein at least one of the multiple active BWPs does not experience beam failure, wherein transmitting the signaling message comprises transmitting a Medium Access Control (“MAC”) Control Element (“CE”), wherein the MAC CE indicates a BWP index for each active BWP experiencing beam failure.

28. The method of claim 26, wherein the signaling message additionally contains candidate beam information for each active BWP experiencing beam failure.

29. A Radio Access Network (“RAN”) apparatus comprising:
a memory; and
a processor coupled to the memory, the processor configured to cause the apparatus to:
configure a remote unit with multiple Bandwidth Parts (“BWPs”), comprising a plurality of downlink (“DL”) BWPs and a plurality of uplink (“UL”) BWPs; and
communicate with the remote unit using multiple active BWPs; and
receive a signaling message from the remote unit in response to the remote unit detecting beam failure for at least one of the multiple active BWPs, the signaling message identifying a serving cell identity (“ID”) and each active BWP experiencing beam failure.

30. The apparatus of claim 29, wherein the processor is configured to cause the apparatus to transmit, to the remote unit, at least one of:
a separate active Transmission Configuration Indicator (“TCI”) per active DL BWP,
a separate set of beam failure detection reference signals (“BFD-RS”) per active DL BWP,
a separate set of DL reference signal (“RS”) resources corresponding to candidate beams per active BWP,
separate one or more Sounding Reference Signals (“SRS”) resource sets per active UL BWP, or a combination thereof.

31. The apparatus of claim 29, wherein the signaling message comprises a Medium Access Control (“MAC”) Control Element (“CE”), wherein the MAC CE indicates a BWP index for each active BWP experiencing beam failure.

32. The apparatus of claim 31, wherein the processor is configured to cause the apparatus to transmit, to the remote unit, a scheduling request (“SR”) resource configuration for the MAC CE, wherein the signaling message is received on configured SR resources.

33. The apparatus of claim 31, wherein the MAC CE indicates that the remote unit does not experience beam failure on at least one of the multiple active BWPs.

34. The apparatus of claim 29, wherein the signaling message comprises transmitting a Beam Failure Recovery (“BFR”) Medium Access Control (“MAC”) Control Element (“CE”), wherein the BFR MAC CE indicates beam failure on the serving cell level.

35. The apparatus of claim 29, further comprising receiving a Random-Access message on a UL BWP having a linked DL BWP, wherein the Random-Access message indicates that the remote unit experiences beam failure at the linked a DL BWP.
